(19) United States
(12) Patent Application Publication
(10) Pub. No.: US 2010/0092113 A1
(43) Pub. Date: Apr. 15, 2010

(54) STATIC PRESSURE SLIDER AND TRANSFERRING DEVICE AND PROCESSING DEVICE PROVIDED WITH THE SAME

(75) Inventor: Takeshi Muneishi, Higashiomi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/294,005

(22) PCT Filed: Mar. 15, 2007
(86) PCT No.: PCT/JP2007/055249

§ 371 Date: May 21, 2009

(30) Foreign Application Priority Data
Mar. 22, 2006 (JP) 2006-079694

(51) Int. Cl. F16C 32/06; G01B 7/14; H02N 11/00; G21K 7/00; G21K 5/10

(52) U.S. Cl. 384/12; 33/712; 310/300; 250/311; 378/34

(57) ABSTRACT

The present invention relates to a static pressure slider including a stationary member 2, and a movable member 3 configured to be movable relative to the stationary member 2 under a condition that a static pressure fluid layer is provided between the stationary member 2 and the movable member 3. The static pressure slider further includes a first conductive layer 25 (26-28), and a second conductive layer 31A (32A-34A) with a distance at least in a portion relative to the first conductive layer 25 (26-28) configured to be changeable by an electrostatic force imposed between the first and second conductive layers 25 (26-28) and 31A (32A-34A). The present invention further relates to a transferring device and a processing device both provided with the static pressure slider.

### TECHNICAL FIELD

The present invention relates to a static pressure slider configured to move a movable member relative to a stationary member in a state that a static pressure fluid layer formed of pressurized fluid is provided between the stationary member and the movable member. Specifically, the present invention relates to a static pressure slider suitable for transferring works in a container such as a vacuum chamber. The present invention further relates to a transferring device and a processing device both provided with the static pressure slider.

### RELATED ART

In a semiconductor manufacturing apparatus, a transferring device called “stage” is used for transferring works such as wafers and masks. The stage includes a guide for guiding the movable member in a predetermined direction. The exemplary guides include a sliding guide, a rolling guide using a plurality of rollers or balls and a static pressure guide using static pressure fluid. The structure of the guide gives an influence over the movement accuracy of the movable member of the stage, or the guiding accuracy (e.g. position accuracy, straightness accuracy) of the stage. In view of the guiding accuracy of the stage, the static pressure guide is considered to have superiority, and thus stages utilizing static pressure guides are widely used.

The stage with the static pressure guide is called a “static pressure slider”, and includes a stationary member constituting a guide, and a movable member on which a work is to be disposed. In this static pressure slider, a pressurized fluid is supplied to a gap between the stationary member and the movable member so as to form a fluid layer. Therefore, it is possible to move the movable member in a predetermined direction without bringing the movable member into contact with the stationary member. In the static pressure slider, the fluid layer serves as a bearing, and generally has a thickness of 5 to 10 μm by supplying a pressurized fluid under a pressure of 3-5 atmospheres.

By utilizing the fluid layer as a bearing for guiding the movable member without contact, the static pressure slider is less likely to be affected by flatness or straightness of the stationary member, differently from the stages utilizing other guides (e.g. sliding guide, rolling guide) of contact type. Thus, the static pressure slider shows excellent guiding accuracy in comparison to other stages utilizing the guides of contact type. Further, since the posture of the movable member is further stabilized in the static pressure slider by reducing the thickness of the fluid layer, it is possible to enhance the guiding accuracy of the stage.

Meanwhile, the semiconductor manufacturing process includes various steps, as a result, various devices are used in the steps. The stage as one of the members of the devices is used within a chamber (vacuum chamber) under vacuum or a reduced-pressure atmosphere. The exemplary devices used in the vacuum chamber include devices for processing and checking the works by charged particles such as electron beam and ion beam, or by electromagnetic radiation of shorter wavelength such as X-ray (a scanning electron microscope (SEM); an electron beam (EB) recorder; a focus ion beam (FIB) recorder; and an X-ray exposure device).

As described above, in the static pressure air slider, a highly pressurized (under 3-5 atmospheres, for example) fluid layer is to be provided between the stationary member and the movable member. In a case where the static pressure slider is used as a stage in a vacuum chamber, there is a need for reducing a leakage of the fluid to the outside of the movable member, that is, into the vacuum chamber. Such a static pressure slider is called as a “vacuum air slider”, as shown in FIG. 17, for example (refer to Patent Document 1).

A vacuum air slider 9 shown in FIG. 17 includes a stationary member 90 and a movable member 91, and is configured to allow air to be supplied and discharged at the movable member 91. The movable member 91 includes a supply portion 92 for supplying a pressurized fluid between the movable member and the stationary member 90, and a discharge portion 93 for discharging the supplied air. The supply portion 92 serves to form a fluid layer with a thickness of about 5 to 10 μm between the stationary member 90 and the movable member 91, and includes a supply path 94 and a throttle 95. The throttle 95 serves to control the amount of supplied fluid, and is provided as an orifice throttle, a surface throttle, or a porous throttle. Meanwhile, the discharge portion 93 includes a discharge port 96 and a discharge path 97, and is to be connected to a non-illustrated pump to discharge the supplied fluid.

As described above, in a static pressure slider such as the vacuum air slider 9, by reducing the thickness of the fluid layer, the position of the movable member 91 is stabilized, thereby enhancing the guiding accuracy. However, in the vacuum slider 9, there is a limit to ensure a relatively high flatness at the stationary member 90 and the movable member 91, and deformation due to own weight of the stationary member 90 is generated. Therefore, when the thickness of the fluid layer is unduly reduced, the movable member 91 may get into contact with the stationary member 90 when the movable member 91 moves, and as a result, “seizing” is generated. In order to avoid such disadvantage, the fluid layer needs a thickness of not less than a predetermined value, and in the vacuum slider 9, the thickness of the fluid layer is limited to not less than about 8 μm.

Then, in order to reduce “seizing”, a vacuum air slider 9′ as shown in FIG. 18 is proposed (refer to Patent Document 2). The illustrated air slider 9′ has a basic structure similar to the vacuum air slider 9 shown in FIG. 17, and includes a stationary member (guiding bar) 90′ and a movable member 91′. In the vacuum air slider 9′, the movable member 91′ includes a labyrinth bulkhead 98′ and a throttle (porous pad) 95′, both formed of an abrasion-resistant porous material. Such structure tries to reduce the contact between metal portions of the stationary member 90′ and the movable member 91′, and tries to avoid “seizing”. In this vacuum air slider 9′, the thickness of the fluid layer is set to about 5 μm, so that the position of the movable member 91′ is stabilized to enhance the guiding accuracy.

In the vacuum air slider 9′ shown in FIG. 18, the thickness of the fluid layer can be smaller than that of the vacuum slider 9 shown in FIG. 17. However, the thickness of the fluid layer, or a gap between the stationary member 90′ and the movable member 91′, which has the most effect on the amount of the fluid leaking into the vacuum chamber, is about 5 μm at best. In order to prevent the pressurized fluid from leaking out of the vacuum air slider 9′, there is a need for driving a vacuum pump of the vacuum chamber, or a vacuum pump connected to a discharge path 97′ of the movable member 91′ with a relatively large exhaust velocity. Further, the amount of the pressurized fluid supplied to the vacuum air slider 9′ is still large. Therefore, a running cost of an apparatus using the vacuum air slider 9′ is increased.

As shown in FIGS. 19A-19C, the vacuum air slider is configured to detect the gap between a labyrinth member 98″ supported to a movable member 91″ and a guiding surface 90A″ of a stationary member 90″ with a sensor 99A″ and then to adjust the gap by controlling a gap adjusting mechanism, based on the detected result (refer to Patent Document 3). An exemplary sensor 99A″ includes a non-contact displacement gauge such as a capacitance type displacement gauge, an eddy current displacement gauge, or an optical displacement gauge. Meanwhile, the gap adjusting mechanism is configured to move the labyrinth member 98″ by using an actuator 99B″ such as a piezoelectric element, a super-magnetostrictive element, and an electromagnet.

However, the vacuum air slider 9″ illustrated in FIGS. 19A-19C, the sensor 99A″ is positioned at the side of the labyrinth to be supported by the movable member 91″, and detects the displacement amount of the labyrinth member 98″. In other words, the sensor of the vacuum air slider 9″ detects, at a position apart from the labyrinth member 98″, a distance between the guiding surface 90A″ of the stationary member 90″ and an facing surface 98A″ of the labyrinth member 98″ which faces the guiding surface 90A″. In this way, in the vacuum air slider 9″, the distance “Hr” of the gap between the guiding surface 90A″ and the labyrinth member 98″ is not directly measured, but the displacement amount ΔHr of the labyrinth member 98″ relative to the guiding surface 90A″ is detected at a position apart from the labyrinth member 98″. Therefore, it is difficult to achieve a precise measurement. As a result, when the labyrinth member 98″ gets into contact with the guiding surface 90A″, the fact is not detected immediately, so that “seizing” is still likely to be generated.

Patent Document 1: U.S. Pat. No. 4,749,283

Patent Document 2: JP-A-2-212624

Patent Document 3: JP-A-2002-3495569

### DISCLOSURE OF THE INVENTION

### Problems to be Solved by the Invention

An object of the present invention is to reduce in a static pressure “seizing” of the movable member relative to a stationary member and a leakage of the pressurized fluid to the outside of the static pressure slider, to improve position stability of a movable member by a thinner fluid layer, and to reduce a running cost by a less amount of a pressurized fluid to be supplied.

A first aspect of the present invention is to provide a static pressure slider including a stationary member, and a movable member configured to be movable relative to the stationary member under a condition that a static pressure fluid layer including a pressurized fluid is provided between the stationary member and the movable member wherein the static pressure slider further includes a first conductive layer formed on the stationary member, and a second conductive layer with a distance at least in a portion from the first conductive layer configured to be changeable by an electrostatic force imposed between the first and second conductive layers.

A static pressure slider according to one of the present invention maybe, configured to adjust, a degree of the electrostatic force imposed between the first and second conductive layers is adjusted based on a capacitance between the first and second conductive layers.

The electrostatic force is imposed between the first conductive layer and the second conductive layer by providing an electric potential difference between the first and second conductive layers.

In the static pressure slider of the present invention, in one of the first and second conductive layers, a dielectric body may be provided between a facing conductive film facing the other conductive layer and a non-facing conductive film, and the electrostatic force may be imposed between the first conductive layer and the second conductive layer by electrically charging surfaces of the facing conductive films by providing an electric potential difference between the facing conductive films and the non-facing conductive films in the conductive layers.

For example, the movable member includes a main body and a displacement body supported by the main body with a distance relative to the stationary member configured to be changeable, and a distance of the second conductive layer relative to the first conductive layer is changeable integrally with the displacement body.

For example, the static pressure slider of the present invention includes a sealing member for sealing a gap between the main body and the displacement body. In this case, the sealing member is compressed by the displacement body.

For example, the second conductive layer is fixed to the movable member through an elastic body, and the elastic body is elastically deformed so as to change the distance relative to the first conductive layer.

The second conductive layer includes a fixing portion fixed to the movable member and a non-fixing portion with a distance relative to the first conductive layer configured to be changeable.

For example, the second conductive layer is a thin plate deformable or displaceable by the electrostatic force. While one end portion of the thin plate forms the fixing portion, the other end portion of a free end forms the non-fixing portion.

For example, the second conductive layer is surrounded by a holder and configured to be an independent member separated from the movable member.

For example, an elastic body is fixed to a portion in contact with the holder in the movable member.

Surfaces of the first and second conductive layers are for example formed to be a smooth surface with a maximum height Rz of not more than 1 μm.

The first and second conductive layers include for example a thick layer formed of a conductive material.

The first and second conductive layers are for example made of a non-magnetic material.

A second aspect of the present invention is to provide a transferring device including the static pressure slider according to the first aspect of the present invention for moving works supported by the movable member, and a container accommodating the static pressure slider.

A third aspect of the present invention is to provide a processing device including the static pressure slider according to the first aspect of the present invention for moving works supported by the movable member, a container accommodating the static pressure slider, and a processing element for checking or processing the works.

The processing element is for example a scanning electron microscope, an electron beam recorder, a focus ion beam recorder, or an X-ray exposure device.

### EFFECT OF THE INVENTION

In the static pressure slider according to one of the present invention, the distance at least in a portion of the second conductive layer relative to the second conductive layer is changed by the electrostatic force acting between the first and second conductive layers. Therefore, it is possible to responsively adjust the gap between the first and second conductive layers. That is, the distance between the first and second conductive layers can be adjusted by the electric potential difference applied between the first and second conductive layers or by electrical charge charged on the facing conductive films of the first and second conductive layers (the electric potential difference between the facing conductive layers and the non-facing conductive layers). Therefore, controlling a power source, makes it possible to responsively control the distance between the first and second conductive layers.

In the static pressure slider of one of the present invention, when the degree of the electrostatic force acting between the first and second conductive layers is adjusted based on the capacitance between the first and second conductive layers, the distance between the stationary member and the movable member can be directly measured as the capacitance between the first and second conductive layers in comparison to a method for indirectly detecting the distance between the stationary member and the movable member. Thus, it is possible to precisely detect the distance between the stationary member and the movable member.

When the movable member (the displacement body) is displaced based on the precisely measured distance, it is possible to properly maintain the distance between the stationary member and the movable member so that the stationary member may be less likely to get too close to the movable member. Thereby, it is possible to prevent the movable member from getting into contact with the stationary member. As a result, “seizing” due to the contact of the movable member to the stationary member can be also prevented, thereby reducing the damages of the stationary member and the movable member. Particularly, when the displacement body is supported and pressed in the direction away from the stationary member, the displacement body can be responsively retracted from the stationary member by using an actuator. Therefore, in the static pressure slider of one of the present invention, the distance between the stationary member and the movable member which is required for preventing the generation of “seizing” can be set to be smaller, and it is possible to further decrease a thickness of the fluid layer to be formed between the stationary member and the movable member.

As a result, the static pressure slider of one of the present invention can improve the position accuracy of the movable member relative to the stationary member, and constantly keep the distance between the stationary member and the movable member relatively small. Therefore, it is possible to reduce the amount of the pressurized fluid to be supplied to between the stationary member and the movable member. Even when the movable member gets into contact with the stationary member, based on the capacitance measured by a measuring unit, the capacitance immediately drops to zero at the time of the contact. Therefore, the contact of the movable member to the stationary member can be immediately detected and the problem due to the contact can be minimumized. Further, since the displacement body is pressed in the direction away from the stationary member, the displacement body can responsively retracted from the stationary member, and the problem due to the contact can be minimumized.

Since the distance between the stationary member and the movable member can constantly be kept relatively small, a leakage of the pressurized fluid to be provided between the stationary member and the movable member can be reduced. Thereby, the vacuum pump for discharging the pressurized fluid from the static pressure slider can be driven by a lower exhaust velocity and lower electrical power consumption. As a result, a cost for discharging the pressurized fluid can be reduced. Further, by reducing the leakage of the pressurized fluid out of the static pressure slider, loss of vacuum in the container can be reduced and thus exhaust velocity and power consumption of the vacuum pump for maintaining the degree of vacuum, the vacuum chamber can be decreased, which makes it possible to reduce the running cost.

In the static pressure slider of one of the present invention, when the electrostatic force acts by providing the electric potential difference between the first conductive layer and the second conductive layer, the electrostatic force acting between those conductive layers is adjusted by the electric potential difference provided between the first conductive layer and the second conductive layer. Therefore, it is possible to responsively adjust the distance between the first conductive layer and the second conductive layer. When the distance between these conductive layers is measured as the capacitance with utilizing the first and second conductive layers, it is possible to both measure the capacitance (the distance between the first and second conductive layers) and to adjust the electric potential difference (the electrostatic force imposed on the first and second conductive layers) by the first and second conductive layers. Therefore, in comparison to a case where a mechanism for measuring the distance between the first and second conductive layers is separately provided, a device structure is simple and a manufacturing cost is advantageous.

In the static pressure slider of one of the present invention, when the electrostatic force acts by providing the electric potential difference between the facing conductive film and the non-facing conductive film in each of the first and second conductive layers to electrically charge surfaces of the facing conductive films, the electrostatic force acting between the first conductive layer and the second conductive layer is adjusted by the electric potential difference provided between the facing conductive films and the non-facing conductive films in the first conductive layer and the second conductive layer. Therefore, as mentioned above, it is possible to responsively adjust the distance between the first conductive layer and the second conductive layer. When the distance between these conductive layers is measured as the capacitance with, utilizing the first and second conductive layers, it is possible to both measure the capacitance (the distance between the first and second conductive layers) and to adjust the electric potential difference (the electrostatic force acting on the first and second conductive layers) by the first and second conductive layers. Therefore, in comparison to the case where the mechanism for measuring the distance between the first and second conductive layers is separately provided, the device structure is simple and the manufacturing cost is advantageous.

In the static pressure slider of one of the present invention, when the distance of the second conductive layer relative to the first conductive layer is changeable integrally with the displacement body, it is possible to responsively adjust the distance between the movable member (the second conductive layer) and the stationary member (the first conductive layer) in comparison to the structure that the distance of the entire movable member relative to the stationary member is changed.

In the static pressure slider of one of the present invention, when the sealing member compressed by the displacement body is further provided between the main body and the displacement body, it is possible to reduce the leakage of the pressurized fluid for forming the fluid layer from a gap between the main body and the displacement body. Particularly, in a case where the displacement body is moved relative to the main body, there is a significant advantage of reducing the leakage of the pressurized fluid by the sealing member.

In the static pressure slider of one of the present invention, when the second conductive layer is fixed to the movable member through the elastic body, the elastic body is provided between the second conductive layer and the movable member. Therefore, the second conductive layer is allowed to move relative to the movable member by expanding and contracting the elastic body, and generation of a gap between the second conductive layer and the movable member is reduced. Consequently, the elastic body can allow the displacement of the second conductive layer as well as reduce the leakage of the pressurized fluid for forming the fluid layer from the gap between the second conductive layer and the movable member.

In the static pressure slider of one of the present invention, when the second conductive layer includes a fixing portion and a non-fixing portion, the gap between the second conductive layer and the fixing portion is less likely generate and the gap between the second conductive layer and the stationary member (the first conductive layer) can be adjusted in the non-fixing portion. As a result, the displacement body can be omitted and there is no need for providing the sealing member between the displacement body and the main body. Therefore, when the second conductive layer includes the fixing portion and the non-fixing portion, simply and advantageously in terms of the manufacturing cost, it is possible to adjust the gap between the movable member and the stationary member while reducing the leakage of the pressurized fluid from the gap.

In the static pressure slider of one of the present invention, when the second conductive layer is a thin plate, the second conductive layer can be easily formed by press working. Therefore, the manufacturing cost is further advantageous.

In the static pressure slider of one of the present invention, when the second conductive layer is an independent member surrounded by the holder, rigidity and durability as the independent member is easily ensured by properly selecting a material or a size of the holder. Thereby, it is possible to improve a handling property of the independent member (the second conductive layer) at the time of manufacturing and ensure the durability at the time of usage. Meanwhile, when the second conductive layer is the independent member, there is no need for a process of fixing the second conductive layer to the movable member. Therefore, workability at the time of manufacturing is improved.

In the static pressure slider of one of the present invention, when the elastic body is fixed to a portion of the movable member in contact with the holder in the elastic body is provided between the holder and the movable member. Therefore, the second conductive layer is allowed to move relative to the movable member by expanding and contracting the elastic body, and the generation of the gap between the second conductive layer and the movable member is reduced. Consequently, the elastic body can allow the displacement of the second conductive layer as well as reduce the leakage of the pressurized fluid for forming the fluid layer from the gap between the second conductive layer and the movable member.

In the static pressure slider of one of the present invention, when the surfaces of the first and second conductive layers are formed to be the smooth surface with a maximum height Rz of not more than 1 μm, in comparison to a case where those conductive layers are formed to be a rough surface, it is possible to reduce possibility that the first and second conductive layers get into contact with each other, that is, possibility that the movable member gets into contact with the stationary member; reduce holes on the surfaces of the stationary member and the movable member; precisely measure the capacitance between the first conductive layer and the second conductive layer; and more surely reduce the leakage of the pressurized fluid. That is, the distance between the stationary member and the movable member which is required for reducing the generation of “seizing” can be set to be small or, and it is possible to further decrease a thickness of the fluid layer to be formed between the stationary member and the movable member.

In the static pressure slider of one of the present invention, when the first and second conductive layers include a thick layer formed of a conductive material, it is possible to easily form the smooth surface without grinding the surfaces of the first and second conductive layers.

In the transferring device and the processing device of one of the present invention, the static pressure slider according to the first aspect of the present invention is provided. Therefore, the amount of the pressurized fluid to be supplied between the stationary member and the movable member can be reduced and the distance between the stationary member and the movable member can constantly be kept relatively small. Consequently, the leakage of the pressurized fluid from the gap between the stationary member and the movable member to the inside of the container is reduced. Thereby, the loss of vacuum in the container can be reduced and thus the exhaust velocity and the electrical power consumption of the vacuum pump for maintaining the degree of vacuum in the vacuum chamber can be decreased. Thus, it is also possible to reduce the running cost in this point.

When the first and second conductive layers of the static pressure slider include the non-magnetic material, even with a case where the processing device is formed so as to use charged particles such as the scanning electron microscope (SEM), the electron beam (EB) recorder, and the focus ion beam (FIB) recorder, the first and second conductive layers do not exercise an adverse effect on operations of those devices.

### BRIEF DESCRIPTION OF THE DRAWINGS

FIG. 1 is a perspective view illustrating a vacuum air slider according to a first embodiment of the present invention.

FIG. 2 is a sectional view taken along line II-II of FIG. 1.

FIG. 3 is a sectional view taken along line III-III of FIG. 1.

FIG. 4 is a partly exploded perspective view of a movable member of the vacuum air slider shown in FIG. 1.

FIG. 5 is a sectional view taken along line V-V of FIG. 4.

FIG. 6 is a sectional view taken along line VI-VI of FIG. 3.

FIG. 7 is a sectional view taken along line VII-VII of FIG. 1.

FIG. 8 is a sectional view enlarging principal portions of FIG. 6.

FIG. 9 is a principal portion exploded perspective view of an end portion of a board in the movable member.

FIG. 10 is a circuit diagram illustrating a detection circuit in the vacuum air slider shown in FIG. 1.

FIG. 11 is a sectional view illustrating a processing device according to the first embodiment of the present invention.

FIG. 12 is a principal portion enlarged sectional view illustrating a vacuum air slider according to a second embodiment of the present invention.

FIG. 13 is a perspective view illustrating a second conductive layer in the vacuum air slider shown in FIG. 12.

FIG. 14 is a principal portion enlarged sectional view illustrating a vacuum air slider according to a third embodiment of the present invention.

FIG. 15 is a principal portion enlarged sectional view illustrating a vacuum air slider according to a fourth embodiment of the present invention.

FIG. 16 is a perspective view illustrating a second conductive layer in the vacuum air slider shown in FIG. 15.

FIG. 17 is a sectional view illustrating an example of a conventional static pressure slider.

FIG. 18 is a sectional view illustrating another example of the conventional static pressure slider.

FIG. 19A is a sectional view illustrating still another example of the conventional static pressure slider, FIG. 19B is a bottom view of FIG. 19A, and FIG. 19C is a sectional view taken along line XIXC-XIXC of FIG. 19B.

### DESCRIPTION OF REFERENCE SYMBOLS

1: Vacuum air slider (static pressure slider)
2: Stationary member
21-24: Guiding surface
25-28: First conductive layer (of stationary member)
3: Movable member
30: Main body (of movable body)
31-34: Displacement body
31A-34A: Second conductive layer
63: Packing (sealing member)
8: Processing device
80: Vacuum container
81: Transferring device
86: Processing element
8A, 8B, 8C: Vacuum air slider (static pressure slider)
80B, 80C: First conductive layer (of stationary member)
80Ba, 80Ca: Facing conductive film (of first conductive layer)
80Bb, 80Cb: Non-facing conductive film (of first conductive layer)
80Bc, 80Cc: Dielectric layer (of first conductive layer)
81B, 81C: Second conductive layer
81Ba, 81Ca: Facing conductive film (of second conductive layer)
81Bb, 81Cb: Non-facing conductive film (of second conductive layer)
81Bc, 81Cc: Dielectric layer (of second conductive layer)
82B: Holder
83C: Elastic body

### BEST MODE FOR CARRYING OUT THE INVENTION

Hereinafter, first to fourth embodiments of the present invention will be described in detail with reference to the drawings.

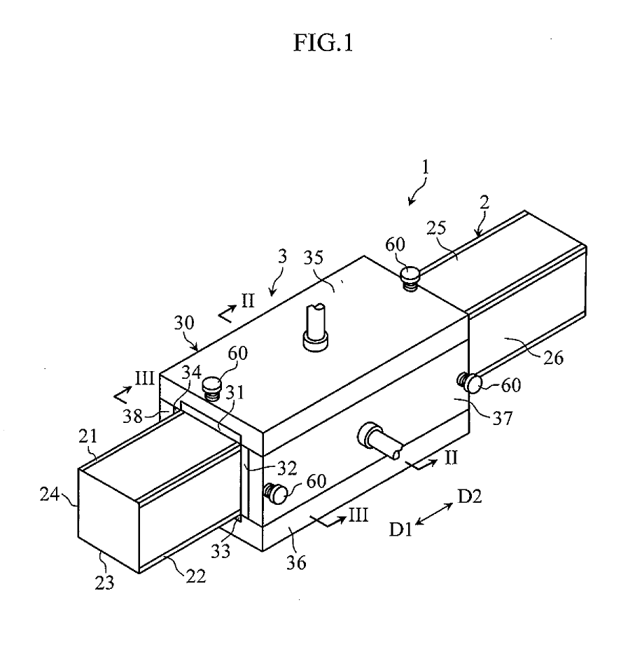

First, the first embodiment of the present invention is described with reference to FIGS. 1-10.

A vacuum air slider 1 shown in FIG. 1, is an exemplary static pressure slider according to the present invention, and is used for transferring works in a vacuum chamber. This vacuum air slider 1 includes a stationary member 2 and a movable member 3. The movable member 3 is configured to be able to move relative to the stationary member 2 in directions D1 and D2, with a fluid layer formed of a pressurized fluid provided between the stationary and movable members 2 and 3.

As shown in FIGS. 1-3, the stationary member 2 serves to guide the movable member 3, and is formed into a rectangular column with four guiding surfaces 21, 22, 23 and 24. This stationary member 2 is made of a ceramics material mainly containing alumina or silicon carbide, for example.

The guiding surfaces 21-24 serve to define a movement path of the movable member 3. Each of the guiding surfaces 21-24 extends in the directions D1 and D2 shown in FIG. 1 and is formed to be a smooth surface, for example. The guiding surfaces 21-24 are provided with first conductive layers 25, 26, 27 and 28, respectively. As specifically described below, the first conductive layers 25-28 are utilized for measuring distances between end portions of the movable member 3 (or displacement bodies 31-35 which are described below) and the stationary member 2, and are formed into a strip-shape extending in the axial direction of the stationary member 2 so as to cover the entire area of the guiding surfaces 21-24.

As shown in FIG. 1, the movable member 3 is operative to move along the guiding surfaces 21-24 of the stationary member 2 in the directions D1 and D2, while surrounding the stationary member 2, and as shown in FIGS. 1-4, includes a main body 30 and the displacement bodies 31, 32, 33 and 34.

The main body 30 includes four boards 35, 36, 37 and 38, and is formed into a tube including a hollow 30A having a rectangular section by connecting these boards 35-38 to each other so that the main body 30 surrounds the stationary member 2.

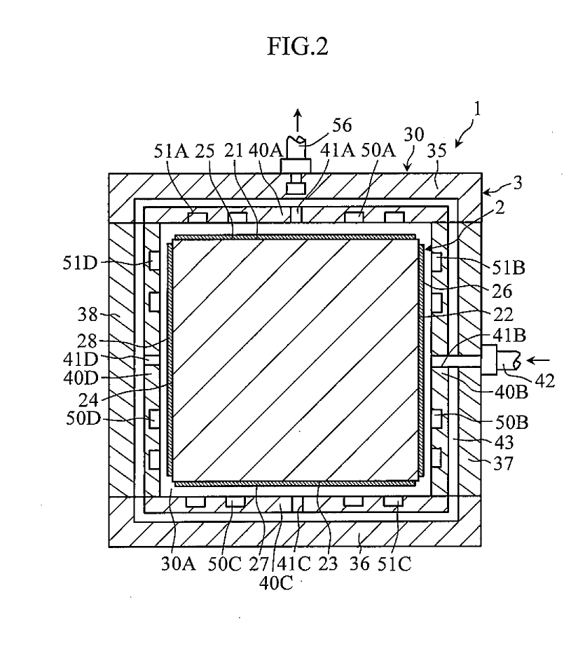

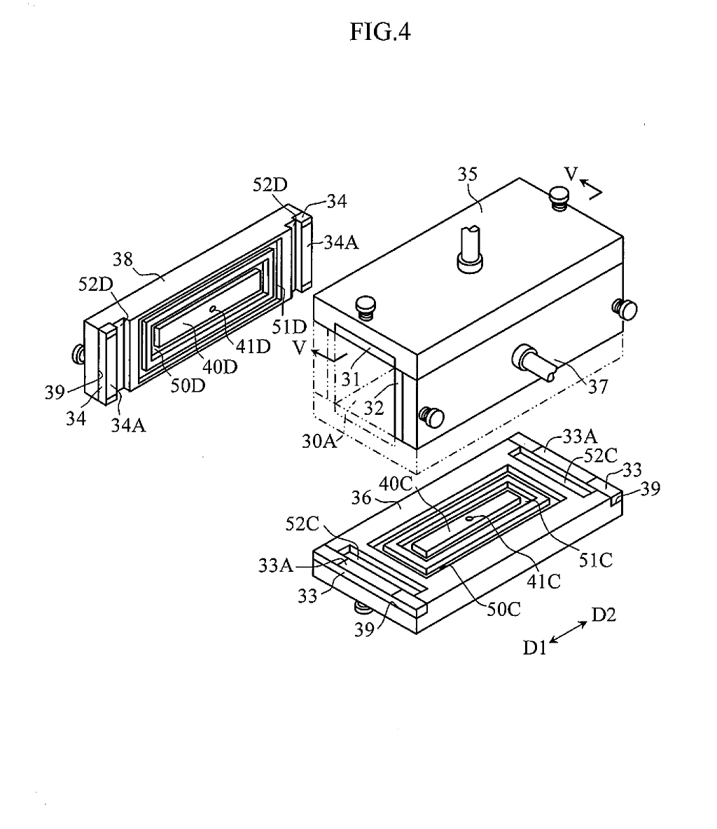

Each of the boards 35-38 is rectangular as seen in plan view. The boards 35 and 36 are horizontally positioned and have a relatively large size, while the boards 37 and 38 are vertically positioned and have a relative small size. As shown in FIGS. 2 and 4, the boards 35-38 respectively include air pads 40A, 40B, 40C and 40D, circular discharge channels 50A, 50B, 50C, 50D, 51A, 51B, 51C and 51D, and linear discharge channels 52A, 52B, 52C and 52D. Similarly to the stationary member 2, the boards 35-38 are made of a ceramics material mainly containing alumina or silicon carbide, for example. Preferably, surfaces of the boards 35-38 to be connected to each other are coated with vacuum grease. In this case, the leakage of a fluid from the connected surfaces can be prevented.

The air pads 40A-40D serve to function as throttles for controlling the amount of a supplied fluid for examples, which are provided as orifice throttles, surface throttles, or porous throttles. As well shown in FIG. 2, the air pads 40A-40D respectively include supply tubes 41A, 41B, 41C and 41D. These supply tubes 41A-41D communicate with a circular supply passage 43 which is connected to a supply pipe 42 provided at the vertical board 37. That is, a pressurized fluid is supplied from the air pads 40A-40D, through the supply pipe 42, the circular supply passage 43 and the supply tubes 41A-41D.

The circular discharge channels 50A-50D and 51A-51D serve to collect the pressurized fluid supplied from the air pads 40A-40D. As may be seen from FIGS. 2 and 4, the circular discharge channels 50A-50D and 51A-51D are formed to surround the air pads 40A-40D. These circular discharge channels 50A-50D and 51A-51D, though not shown in the drawings, communicate with an outside of a vacuum chamber (not shown in the drawings) through a discharge pipe so that the pressurized fluid is discharged out of the vacuum chamber.

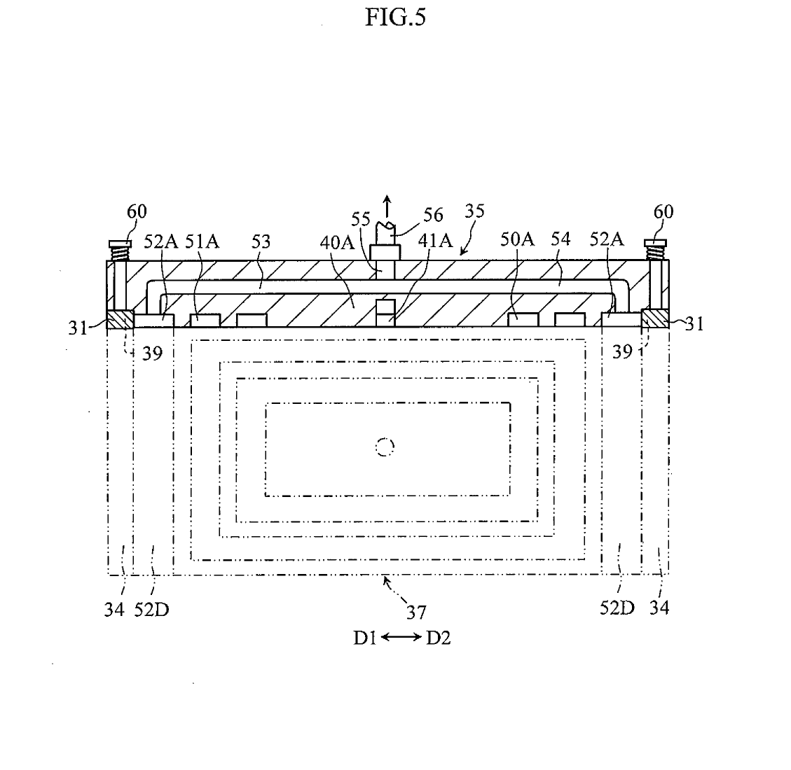

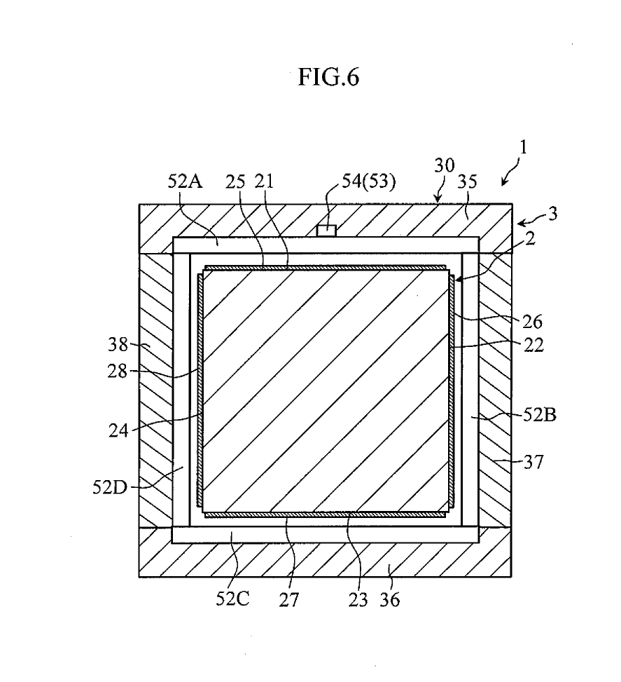

As may be seen from FIGS. 4-6, the linear discharge channels 52A-52D communicate with each other while connecting the boards 35-38, and serve as a circular discharge channel of the main body 30 as a whole. As well shown in FIGS. 4 and 6, these linear discharge channels 52A-52D are provided at the end portions of the boards 35-38 in the longitudinal directions D1 and D2, and extend in the width direction of the boards. The linear discharge channels 52B and 52D of the vertical boards 37 and 38 are formed to reach the side edges of the boards, and are open in its end of width direction. On the other hand, the linear discharge channels 52A and 52C of the horizontal boards 35 and 36 are formed at portions except the side edges of the boards, and are closed in its end. As shown in FIGS. 5 and 6, the linear discharge channel 52A of the horizontal board 35 communicates with discharge passages 53 and 54. These discharge passages 53 and 54 are connected to a vacuum pump (not shown in the drawings) provided outside of the vacuum chamber, via a common discharge passage 55 and a discharge pipe 56. That is, the pressurized fluid is discharged out of the vacuum chamber, from the linear discharge channels 52A-52D through the discharge passages 53 and 54, the common discharge passage 55 and the discharge pipe 56 by driving the vacuum pump.

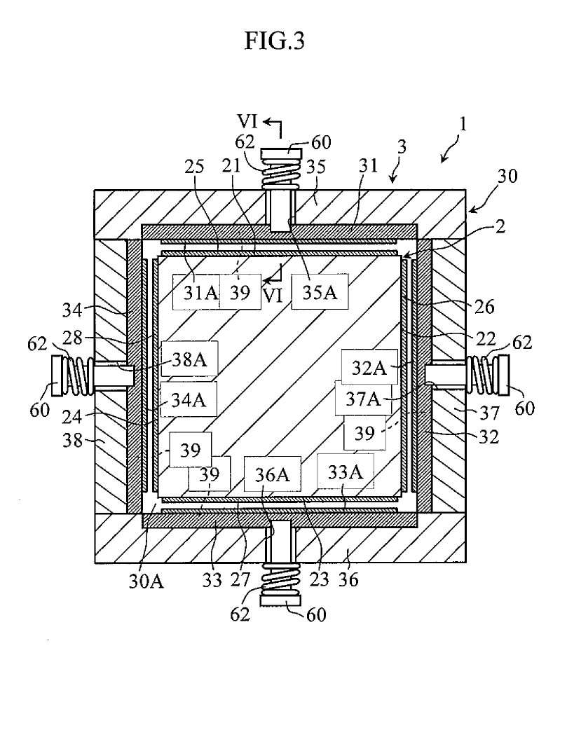

As shown in FIGS. 3-5, the displacement bodies 31-34 serve to prevent the movable member 3 from getting into contact with the stationary member 2, while maintaining gaps between the end portions of the movable member 3 and the stationary member 2 to be smaller. The displacement bodies 31-34 are formed into a bar-shape with a rectangular section. These displacement bodies 31-34 are supported to the end portions of the boards 35-38 in the directions D1 and D2 using bolts 60, and are displaceable by actuators 61 in the thickness direction of the boards 35-38.

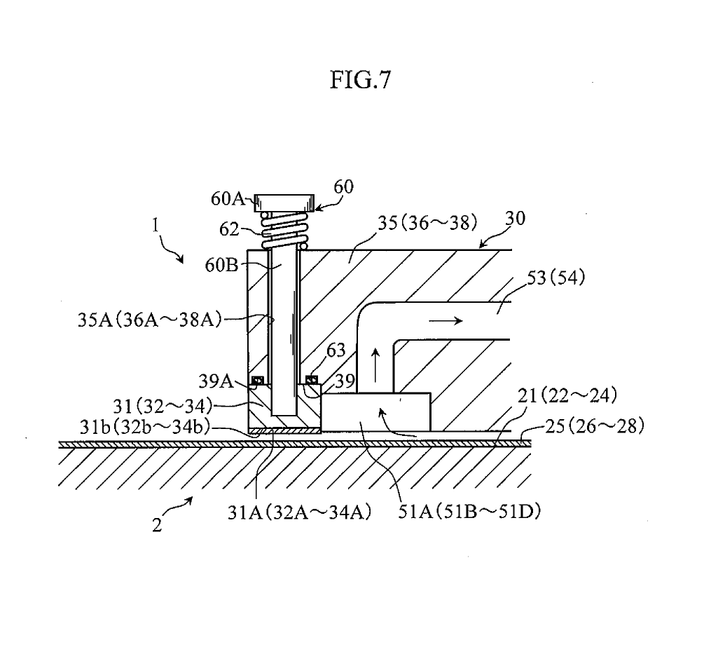

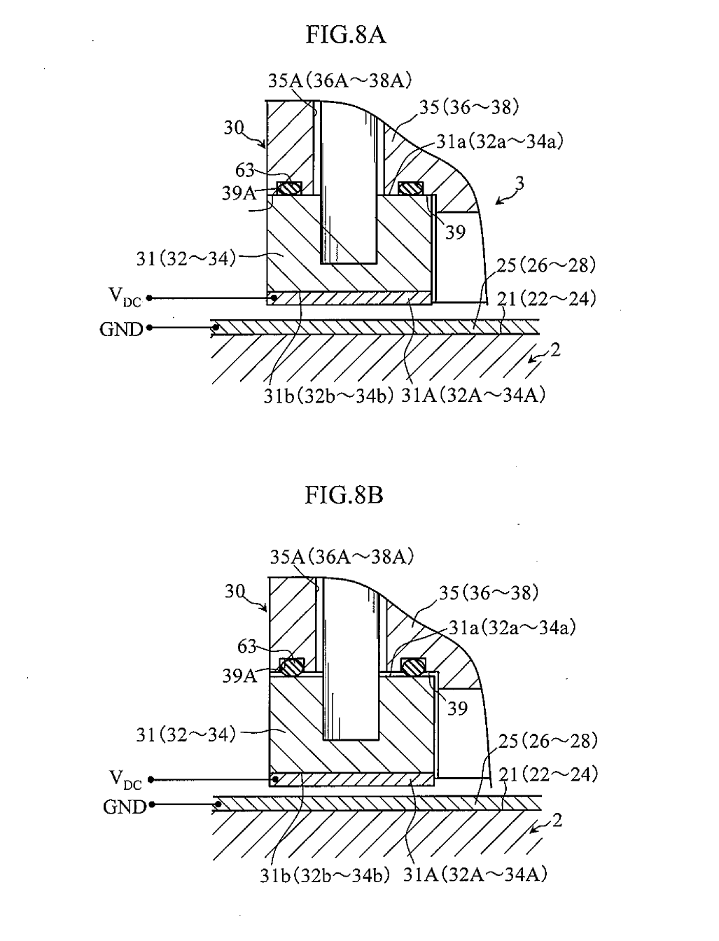

As shown in FIGS. 7 and 8, the displacement bodies 31-34 are accommodated in recesses 39 formed at the end portions of the boards 35-38, adjacent to the linear discharge channels 52A-52D, while being integrated with the boards 35-38 by the bolts 60. In this state, the displacement bodies 31-34 positioned adjacent to the linear discharge channels 52A-52D protrude beyond the main body 30 of the movable member 3 slightly (by about 1 to 10 μm), and include end surfaces 31A, 32A, 33A and 34A facing the guiding surfaces 21-24 (the surfaces of the conductive layers 25-28) of the stationary member 2, substantially parallel thereto. With such structure of the displacement bodies 31-34 protruding beyond the main body 30 of the movable member 3, the leakage of the pressurized fluid out of the movable member 3 is reduced, and the pressurized fluid can be properly guided to the linear discharge channels 52A-52D. In a case where the linear discharge channels 52A-52D are closed to the middle portion of the main body 30 of the movable member 3 than the end portion of the main body 30, the displacement bodies 31-34 may be also positioned in the vicinity of the linear discharge channels 52A-52D, preferably positioned on a side of the end portions adjacent to the linear discharge channels 52A-52D.

As shown in FIG. 7, each of the bolts 60 includes a head 60A, a coil spring 62 positioned between the head 60A and each of the boards 35-38, and a screw 60B inserted in each of through holes 35A, 36A, 37A and 38A of the boards 35-38. The coil spring 62 is compressed from the natural state. Each of the through holes 35A-38A has a diameter larger than the screw 60B of the bolt 60. Thus, the displacement bodies 31-34 are pressed toward the head 60A due to the elastic force of the coil spring 62, and are displaceable in the thickness direction of the boards 35-38.

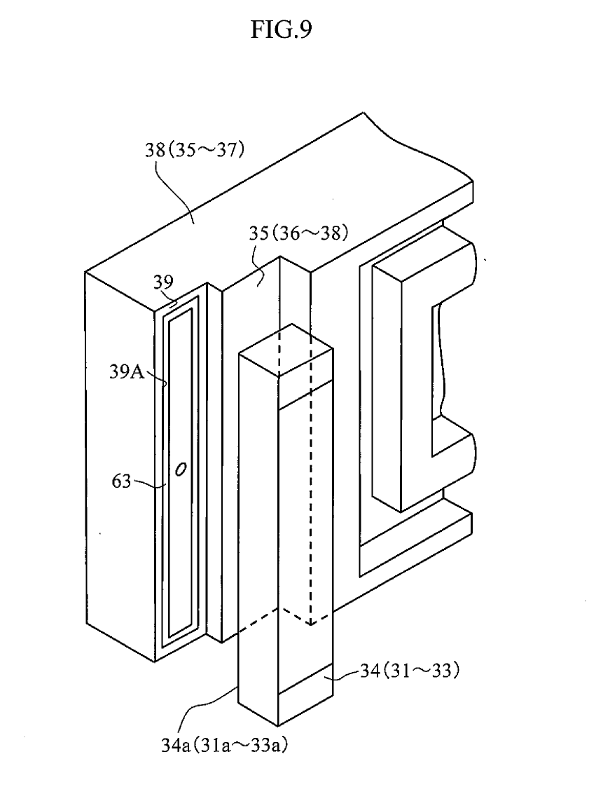

As shown in FIGS. 7 and 8, packings 63 are provided as sealing members between the displacement bodies 31-34 and the main body 30. As seen from FIG. 9, each of these packings 63 is rectangular, and has a circular section as seen from FIGS. 7 and 8. These packings 63 are made of an elastic material such as rubber, and are arranged in circular grooves 39A formed in the recesses 39 of the boards 35-38 as shown in FIGS. 7-9. These circular grooves 39A face end surfaces 31a, 32a, 33a and 34a of the displacement bodies 31-34 and extend along edges of the end surfaces 31a-34a of the displacement bodies 31-34. The packings 63 accommodated in these circular grooves 39A are positioned between the boards 35-38 (the circular grooves 39A) and the end surfaces 31a-34a of the displacement bodies 31-34 in a manner that the packings 63 contacts with the boards 35-38 and the end surfaces 31a-34a of the displacement bodies 31-34. In this state, the packings 63 surround the edges of the through holes 35A-38A of the boards 35-38. Therefore, as shown in FIGS. 8A and 8B, in a case where the displacement bodies 31-34 are displaced, the packings 63 expand and contract by their elasticity according to the displacement of the displacement bodies 31-34 so that gaps generated between the boards 35-38 and the displacement bodies 31-34 can be sealed. As a result, it is possible to prevent the pressurized fluid from leaking outside of the vacuum air slider 1 from the gaps between the boards 35-38 and the end surfaces 31a-34a of the displacement bodies 31-34 and also prevent the pressurized fluid from leaking outside of the vacuum air slider 1 via the through holes 35A-38A of the boards 35-38.

The sealing member may, of course, include an elastic material other than the rectangular packings 63.

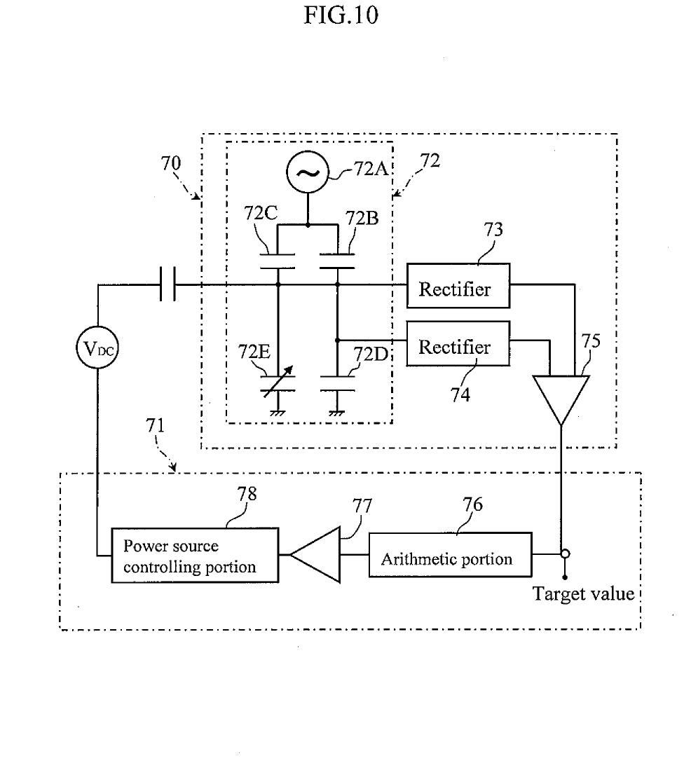

As shown in FIGS. 3, 4, 7 and 8, end surfaces 31b, 32b, 33b and 34b of the displacement bodies 31-34 are respectively provided with second conductive layers 31A, 32A, 33A and 34A facing the first conductive layers 25-28 of the stationary member 2. These second conductive layers 31A-34A are utilized, together with the first conductive layers 25-28 of the stationary member 2, for detecting the distances between the end portions of the movable member 3 and the stationary member 2. That is, the first conductive layers 25-28 and the second conductive layers 31A-34A form a variable capacitor 72E in a detection circuit 70 (see FIG. 10) which is described below. An electrostatic force acts between those conductive layers 25-28 and 31A-34A by a DC power source V_{DC} (see FIG. 10) which is described below. Each of the second conductive layers 31A-34A is rectangular as seen in plan view. Each of the second conductive layers 31A-34A has a length the same as the width of the first conductive layers 25-28 of the stationary member 2, and a width the same as the width of the displacement bodies 31-34. The distances of the second conductive layers 31A-34A relative to the first conductive layers 25-28 are changed so as to change the gaps formed between the stationary member 2 and the end portions of the movable member 3 (the displacement bodies 31-34) by the electrostatic force acting between the second conductive layers 31A-34A and the first conductive layers 25-28. Therefore, it is possible to uniformize the gaps.

The first conductive layers 25-28 of the stationary member 2 and the second conductive layers 31A-34A of the displacement bodies 31-34 are preferably a smooth surface with a surface roughness where a maximum height Rz (based on JIS B0601-2001) is 1 μm or less, for example. When the first conductive layers 25-28 and the second conductive layers 31A-34A are formed to be the smooth surface, in comparison to a case where those conductive layers 25-28 and 31A-34A are formed to be a rough surface, it is possible to reduce possibility that the first conductive layer 25-28 and the second conductive layers 31A-34A get into contact with each other, that is, possibility that the end portions of the movable member 3 (the displacement bodies 31-34) gets into contact with the stationary member 2. Even when the stationary member 2 and the displacement bodies 31-34 get into contact with each other, it is possible to immediately detect the fact. Further, since the gaps formed between the stationary member 2 and the displacement bodies 31-34 are uniformized, it is possible to reduce the leakage of the pressurized fluid. That is, the distance between the stationary member and the movable member which is required for preventing the generation of “seizing” can be set to be smaller, and it is possible to further decrease a thickness of the fluid layer to be formed between the stationary member 2 and the movable member 3.

In order to have the smooth surface, the first conductive layers 25-28 and the second conductive layers 31A-34A may be grinded, or may be formed of a single crystal. Further, the first conductive layers 25-28 and the second conductive layers 31A-34A may be a thick layer by metal in order to offset surface irregularities and holes on the guiding surfaces 21-24 of the stationary member 2 and the end surfaces 31b-34b of the displacement bodies 31-34, so as to have smooth surface. For example, in a case where the stationary member 2 and the displacement bodies 31-34 are made of a ceramics material, the surface roughness after grinding process has an arithmetic mean roughness Ra (based on JIS B0601-2001) of a couple of micrometers to tens of micrometers. In order to efficiently offset the surface irregularities and the holes, the thickness of the first conductive layers 25-28 and the second conductive layers 31A-34A may be set to 0.1 mm or more, for example.

The first conductive layers 25-28 and the second conductive layers 31A-34A may be formed as rigid film in order to reduce “seizing” caused by the contact of the layers. By reducing the problem such as “seizing” caused by the contact of the first conductive layers 25-28 and the second conductive layers 31A-34A, it is possible to further decrease the thickness of the fluid layer provided between the stationary member 2 and the movable member 3.

The hardness of the first conductive layers 25-28 and the second conductive layers 31A-34A is preferably set to be 1200 in Vickers hardness Hv or more. The rigid film (the conductive layers 25-28, 31A-34A) with such hardness may be made of TiN, TiC, cermet, AlTiC, or WC. Here, the Vickers hardness Hv is measured based on JIS R1610.

Further, the first conductive layers 25-28 and the second conductive layers 31A-34A are preferably formed to be non-magnetic. When the first conductive layers 25-28 and the second conductive layers 31A-34A are made of the non-magnetic material, even with a case where the vacuum air slider 1 is used in devices utilizing charged particles such as the scanning electron microscope (SEM), the electron beam (EB) recorder, and the focus ion beam (FIB) recorder, the first conductive layers 25-28 and the second conductive layers 31A-34A do not exercise an adverse effect on a charged particle control of those devices. Therefore, it is possible to use the vacuum air slider 1 according to the present invention in the devices utilizing the charged particles.

As shown in FIG. 10, the vacuum air slider 1 further includes the DC power source V_{DC}, the detection circuit 70, and a controlling portion 71, in addition to the stationary member 2 and the movable member 3.

The DC power source V_{DC} serves to provide an electric potential difference between the first conductive layer 25 (26-28) and the second conductive layer 31A (32A-34A) so as to impose the electrostatic force.

The detection circuit 70 serves to measure a capacitance between the first conductive layer 25 (26-28) and the second conductive layer 31A (32A-34A) (see FIG. 7) and includes an AC bridge 72, two rectifiers 73 and 74, and a difference amplifier 75.

The AC bridge 72 includes an AC oscillator 72A, three condensers 72B, 72C and 72D with a known capacitance, and the variable capacitor 72E. By applying AC voltage by the AC oscillator 72A, the electric potential difference in accordance with a capacity of the capacity variable capacitor 72E is outputted. Here, the variable capacitor 72E includes the first conductive layer 25 (26-28) of the stationary member 2 and the second conductive layer 31A (32A-34A) of the movable member 3. That is, the AC bridge 72 is configured to output the electric potential difference in accordance with the capacitance between the first conductive layer 25 (26-28) and the second conductive layer 31A (32A-34A). The capacitance between the first conductive layer 25 (26-28) and the second conductive layer 31A (32A-34A) is changed in accordance with the distance between these conductive layers 25 (26-28) and 31A (32A-34A). Therefore, the output from the AC bridge 72 makes it possible to detect the distance between the first conductive layer 25 (26-28) and the second conductive layer 31A (32A-34A), that is, the distances between the end surfaces 31b-34b of the displacement bodies 31-34 and the guiding surfaces 21-24 of the stationary member 2 (see FIG. 8).

The rectifiers 73 and 74 serve to convert the AC voltage outputted from the AC bridge 72 into DC voltage and also reduce an influence of noise content. Any of a half wave rectifier and a full wave rectifier can be used as the rectifiers 73 and 74.

The difference amplifier 75 serves to amplify the output from the AC bridge 72 converted into the DV voltage by the rectifiers 73 and 74 to output the amplified output from the detection circuit 70.

The controlling portion 71 serves to control the DC power source V_{DC} based on the output from the detection circuit 70 (the difference amplifier 75). This controlling portion 71 is configured to control the DC power source V_{DC} by for example a PID control and includes an arithmetic portion 76, an amplifier 77 and a power source controlling portion 78. The arithmetic portion 76 serves to calculate the control amount relative to the DC power source V_{DC} from a difference between the output of the difference amplifier 75 and a preliminarily fixed target value. Here, the target value is set as a value corresponding to a target distance (a proper distance) between the first conductive layer 25 (26-28) and the second conductive layer 31A (32A-34A). The amplifier 77 serves to amplify the control amount calculated in the arithmetic portion 76 and input the control amount to the power source controlling portion 78. The power source controlling portion 78 serves to adjust a value of voltage to be applied by the DC power source V_{DC} in accordance with the inputted control amount. That is, the distance between the first conductive layer 25 (26-28) and the second conductive layer 31A (32A-34A) is adjusted by adjusting the applied voltage in DC power source V_{DC} by the power source controlling portion 78.

The arithmetic portion 76 and the power source controlling portion 78 can be constructed by combining a CPU, a RAM and a ROM for example and causing the CPU to execute a program stored in the ROM while using the RAM. The arithmetic portion 76 and the power source controlling portion 78 may be separately provided for each of the displacement bodies 31-34. One arithmetic portion 76 and one power source controlling portion 78 may be provided so as to correspond to all the displacement bodies 31-34. The arithmetic portion 76 may be separately provided for each of the displacement bodies 31-34, while one power source controlling portion 76 is provided so as to correspond to all the displacement bodies 31-34. Further, the arithmetic portion 76 and the power source controlling portion 78 may not be provided in the vacuum air slider 1 but provided separately from the vacuum air slider 1. For example, in a device used with installing the vacuum air slider 1, positions of the displacement bodies 31-34 of the vacuum air slider 1 may be controlled by an arithmetic portion and a controlling portion.

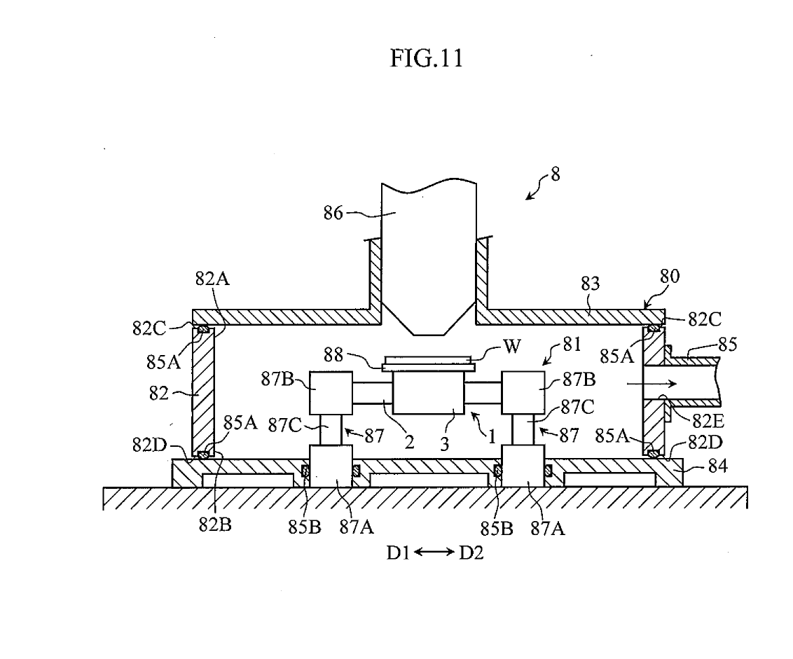

Next, a processing device 8 provided with the vacuum air slider 1 is described with reference to FIG. 11.

The processing device 8 shown in FIG. 11 accommodates a transferring device 81 inside a vacuum container 80.

The vacuum container 80 includes a side wall 82 formed by an angular tube or a circular tube, a lid 83 and a table 84. Gaps between end surfaces 82C and 82D of the side wall 82 and the lid 83 and the table 84 are sealed by sealing members 85A. A discharge port 82E is formed in the side wall 82. This discharge port 84E communicates with the inside of a discharge pipe 85 connected to the side wall 82. The discharge pipe 85 is connected to a vacuum pump (not shown) and it is possible to discharge the inside of the vacuum container 80 through the discharge pipe 85 and the discharge port 82E so as to obtain a high vacuum state.

The lid 83 serves to play a role of closing an upper opening 82A of the side wall 82 and support a processing element 86. The processing element 86 serves to check or process works W disposed on a supporting base 88 which is described below. The processing element 86 is for example the scanning electron microscope, the electron beam recorder, the focus ion beam recorder, or an X-ray exposure device.

The table 84 serves to play a role of closing a lower opening 82B of the side wall 82 and support the vacuum air slider 1 of the transferring device 81.

The transferring device 81 serves to transfer the works W to be checked and processed in the processing element 86 in the directions D1 and D2. The works W are for example a semiconductor wafer, or a mask. The transferring device 81 is provided with the vacuum air slider 1 and a supporting mechanism 87. The supporting mechanism 87 includes a pair of bases 87A, a pair of connection portions 87B and a pair of supporting legs 87C. A pair of the bases 87A is supported relative to a stone surface plate 89 in a state of being away from each other by a fixed distance in the directions D1 and D2. These bases 87A are further inserted into through holes 84A of the table 84. Gaps between peripheral surfaces 87Aa of the bases 87A and the through holes 84A are sealed by sealing members 85B. The connection portions 87B serve to connect end portions of the stationary member 2 of the vacuum air slider 1 and the supporting legs 87C. The supporting legs 87C serve to support the vacuum air slider 1 at an upper position of the table 84 and the stone surface plate 89.

Next, an operation of the processing device 8 is described.

In the processing device 8, gas inside the container 80 is discharged through the discharge port 82E and the discharge pipe 85 so as to make the inside of the container 80 vacuum. Meanwhile, the works W to be checked or processed are disposed on the supporting base 88 of the vacuum air slider 1.

In the vacuum air slider 1, the movable member 3 is moved relative to the stationary member 2 by, for example, a non-illustrated actuator. Thereby, a targeted portion of the works W is to face the processing element 86. At this time, the movable member 3 is moved under a condition that the fluid layer is provided between the movable member 3 and the stationary member 2.

The fluid layer is provided using a non-illustrated pump, by supplying a pressurized fluid from the air pads 40A-40D, through the supply pipe 42, the circular supply passage 43, and the supply tubes 41A-41D. Meanwhile, the pressurized fluid is discharged out of the container 80, through the circular discharge channels 50A-50D and 51A-51D of the boards 35-38 and a non-illustrated discharge pipe. Some of the pressurized fluid which is not discharged from the circular discharge channels 50A-50D and 51A-51D is discharged from other circular discharge channels formed by the linear discharge channels 52A-52D of the boards 35-38. The pressurized fluid guided to these circular discharge channels (the linear discharge channels 52A-52D) is sucked by the vacuum pump (not shown in the drawings) provided outside of the container 80 and discharged out thereof, through the discharge passages 53 and 54, the common discharge passage 55 and the discharge pipe 56.

Meanwhile, in the detection circuit 70, the distances between the stationary member 2 and the end portions of the movable member 3 are directly measured as the capacitance between the first conductive layers 25-28 of the stationary member 2 and the second conductive layers 31A-34A of the displacement bodies 31-34 in the movable member 3. The capacitance between the first conductive layers 25-28 and the second conductive layers 31A-34A is outputted from the AC bridge 72 as the electric potential difference corresponding to the capacitance, then made to be DC content in the rectifiers 73 and 74, amplified by the difference amplifier 75 and outputted from the detection circuit 70.

The output from the detection circuit 70 (the difference amplifier 75) is inputted to the controlling portion 71. In the controlling portion 71, the output from the difference amplifier 75 and a target value are compared to each other so as to the control amount relative to the DC power source V_{DC}. That is, the controlling portion 71 detects the displacement amount from the proper distances between the first conductive layers 25-28 and the second conductive layers 31A-34A based on the output from the difference amplifier 75 and the target value and calculates the control amount corresponding to the displacement amount in the arithmetic portion 76. A calculation result in the arithmetic portion 76 is amplified in the amplifier 77 and then inputted to the power source controlling portion 78. The power source controlling portion 78 controls the DC power source V_{DC} based on the control amount which is preliminarily calculated. That is, the power source controlling portion 78 controls the DC power source V_{DC} and adjusts the electric potential difference between the first conductive layers 25-28 and the second conductive layers 31A-34A so as to adjust the electrostatic force (the distances) acting between the first conductive layers 25-28 and the second conductive layers 31A-34A.

For example, in a case where the distances between the first conductive layers 25-28 and the second conductive layers 31A-34A are smaller than the proper distances, that is, in a case where the displacement bodies 31-34 (the end portions of the movable member 3) get too close to the stationary member 2, the voltage (the electrostatic force) to be applied by the DC power source V_{DC} is increased so as to move the displacement bodies 31-34 in the direction apart from the stationary member 2. Conversely, in a case where the distances between the first conductive layers 25-28 and the second conductive layers 31A-34A are larger than the proper distances, that is, in a case where the displacement bodies 31-34 (the end portions of the movable member 3) get too distant from the stationary member 2, the voltage to be applied by the DC power source V_{DC} is decreased so as to move the displacement bodies 31-34 in the direction coming close to the stationary member 2.

The detection of the capacitance (the distances) in the detection circuit 70, the calculation of the control amount in the controlling portion 71 and the adjustment of the electrostatic force (the distances) in the power source controlling portion 78 are continuously performed at least while the movable member 3 is moved relative to the stationary member 2.

The processing device 8 checks or processes a portion of the works W facing the processing element 86.

In the vacuum air slider 1, the distances between the stationary member 2 and the end portions of the movable member 3 (the displacement bodies 31-34) can be directly measured as the capacitance at the facing portion of these members. Therefore, in the processing device 8, it is possible to precisely detect the distances between the stationary member 2 and the end portions of the movable member 3 (the displacement bodies 31-34). The measurement accuracy is remarkably improved, in comparison to for example a method in which the distances between the stationary member 2 and the end portions of the movable member 3 (the displacement bodies 31-34) are calculated based on the result of measuring the distances at a portion other than the facing portion of the members.

Displacing the end portions of the movable member 3 (the displacement bodies 31-34) based on the precisely measured distances makes it possible to maintain the distance between the stationary member 2 and the movable member 3 to be very small, and prevent the stationary member 2 from getting too close to the movable member 3 more than necessary. Thereby, since the movable member 3 can be prevented from getting into contact with the stationary member 2, it is possible to prevent the generation of “seizing” due to the contact of the movable member 3 to the stationary member 2. Particularly, by supporting the displacement bodies 31-34 pressed in the direction apart from the stationary member 2, it is possible to responsively retract the displacement bodies 31-34 from the stationary member 2 when the electrostatic force acting between the first conductive layers 25-28 and the second conductive layers 31A-34A is changed. Therefore, the distance between the stationary member 2 and the movable member 3 which is required for preventing the generation of “seizing” can be set to be smaller, and thus the thickness of the fluid layer to be provided between the stationary member 2 and the movable member 3 can also be decreased. As a result, in the vacuum air slider 1, the position accuracy of the movable member 3 relative to the stationary member 2 can be improved, and the amount of the pressurized fluid to be supplied between the stationary member 2 and the movable member 3 can be reduced. When the amount of the pressurized fluid to be supplied is reduced, it is possible to reduce the leakage of the pressurized fluid to the outside of the vacuum air slider 1 (the inside of the container 80). Thereby, the vacuum pump for discharging the pressurized fluid from the vacuum air slider 1 only needs reduced exhaust velocity and the electrical power consumption. As a result, it is possible to reduce the cost for discharging the pressurized fluid. Further, the reduced leakage of the pressurized fluid from the static pressure slider can reduce, the loss of vacuum in the container 80 can. Therefore, it is possible to reduce the exhaust velocity and the electrical power consumption for maintaining the degree of vacuum in the container 80. Thus, the running cost of the static pressure slider is reduced also in this point.

Even when the movable member 3 gets into contact with the stationary member 2 based on the capacitance detected by the detection circuit 70, the contact of the movable member 3 to the stationary member 2 can be immediately detected. That is, in a case where the movable member 3 gets into contact with the stationary member 2, the first conductive layers 25-28 and the second conductive layers 31A-34A are in contact with each other and the electrostatic force detected in the detection circuit 70 is remarkably changed so that the contact of the movable member 3 to the stationary member 2 can be immediately detected. When the contact of the movable member 3 to the stationary member 2 can be immediately detected, the displacement bodies 31-34 are retracted from the stationary member 2 by adjusting the electric potential difference between the first conductive layers 25-28 and the second conductive layers 31A-34A and adjusting the electrostatic force imposed on those conductive layers 25-28 and 31A-34A, as a result, the problem due to the contact is minimumized.

Meanwhile, when the distance between the stationary member 2 and the movable member 3 is maintained properly, it is possible to prevent an unnecessarily large gap formed between the stationary member 2 and the movable member 3. Therefore, it is possible to reduce the leakage of the pressurized fluid to the outside of the vacuum air slider 1 (the inside of the container 80). This also contributes to reduction in the cost for discharging the pressurized fluid out of the vacuum air slider 1, and for maintaining the degree of vacuum of the container 80.

Further in the static pressure slider 1, the electric potential difference (the electrostatic force) acting between the first conductive layers 25-28 and the second conductive layers 31A-34A imposed, it is possible to responsively adjust the distances between those conductive layers 25-28 and 31A-34A. When both the capacitance (the distances between the first and second conductive layers 25-28 and 31A-34A) is measured and the electric potential difference (the electrostatic force imposed on the first and second conductive layers 25-28 and 31A-34A) is adjusted with utilizing the first and second conductive layers 25-28 and 31A-34A, in comparison to a case where a mechanism for measuring the distances between the first and second conductive layers 25-28 and 31A-34A is separately provided, a device structure is simple and a manufacturing cost is advantageous.

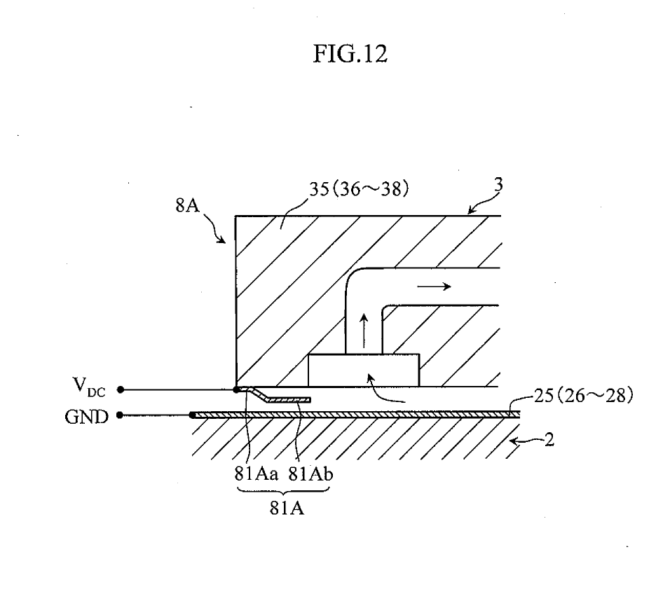

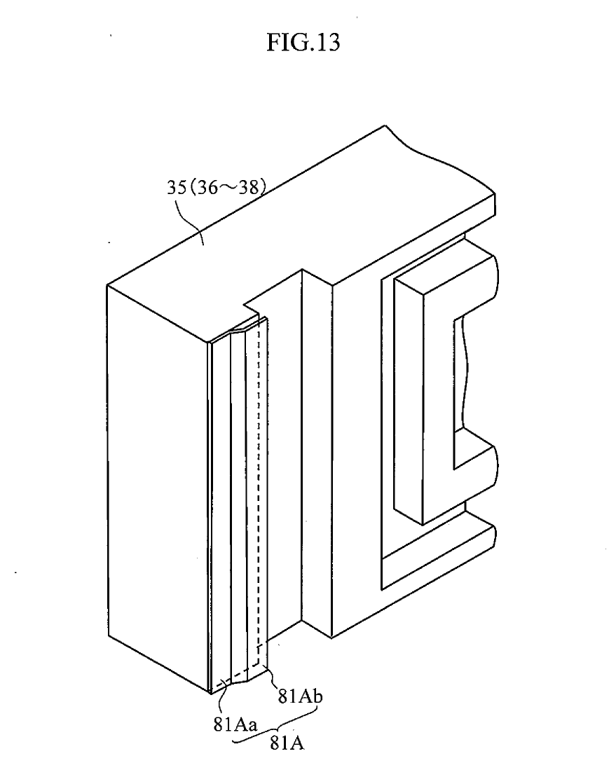

Next, the second embodiment of the present invention is described below with reference to FIGS. 12 and 13. In these drawings, elements identical to those in the static pressure slider 1 according to the first embodiment (see FIGS. 1-10) are given the same reference numbers and duplicated description is not shown.

A static pressure slider 8A shown in FIGS. 12 and 13 has the same basic structure as the static pressure slider 1 according to the first embodiment (see FIGS. 1-9), but has a different structure of a second conductive layer 81A from this static pressure slider 1.

The second conductive layer 81A is formed so as to extend in the width direction of the board 35 (36-38) in an end portion of the board 35 (36-38) of the movable member 3. This second conductive layer 81A is a thin plate such as a plate spring, and includes a fixing portion 81Aa and a non-fixing portion 81Ab. The fixing portion 81Aa serves to fix the second conductive layer 81A to the movable member 3. The non-fixing portion 81Ab is a free end and includes a liner shaped portion. That is, since the non-fixing portion 81Ab includes the liner shaped portion, the electrostatic force acting between the first and second conductive layers 25 (26-28) and 81A is easily ensured to be large and a contact area (contact resistance) when the second conductive layer 81A gets into contact with the first conductive layer 25 (26-28) can be ensured to be large.

In the static pressure slider 8A, the non-fixing portion 81Ab of the second conductive layer 81A is a free end. Therefore, adjusting the degree of the electrostatic force acting between the first conductive layer 25 (26-28) and the second conductive layer 81A makes it possible to adjust the distance between the first conductive layer 25 (26-28) and the non-fixing portion 81Ab.

In the static pressure slider 8A, generation of a gap between the second conductive layer 81A and the fixing portion 81Aa is reduced and a gap between the second conductive layer 81A and the stationary member 2 (the first conductive layer 25 (26-28)) can be adjusted in the non-fixing portion 81Ab. As a result, the displacement body 31 (32-34) (see FIGS. 7 and 8) can be omitted and there is no need for providing the sealing members 63 (see FIGS. 7 and 8) between the displacement body 31 (32-24) and the main body 30. Therefore, when the second conductive layer 81A includes the fixing portion 81Aa and the non-fixing portion 81Ab, simply and advantageously in terms of the manufacturing cost, it is possible to adjust the gap between the movable member 3 and the stationary member 2 while reducing the leakage of the pressurized fluid from the gap.

When the second conductive layer 81A is a thin plate such as a plate spring, the second conductive layer 81A can be easily formed by pressing a conductive plate such as a metal. Therefore, the manufacturing cost is further advantageous.

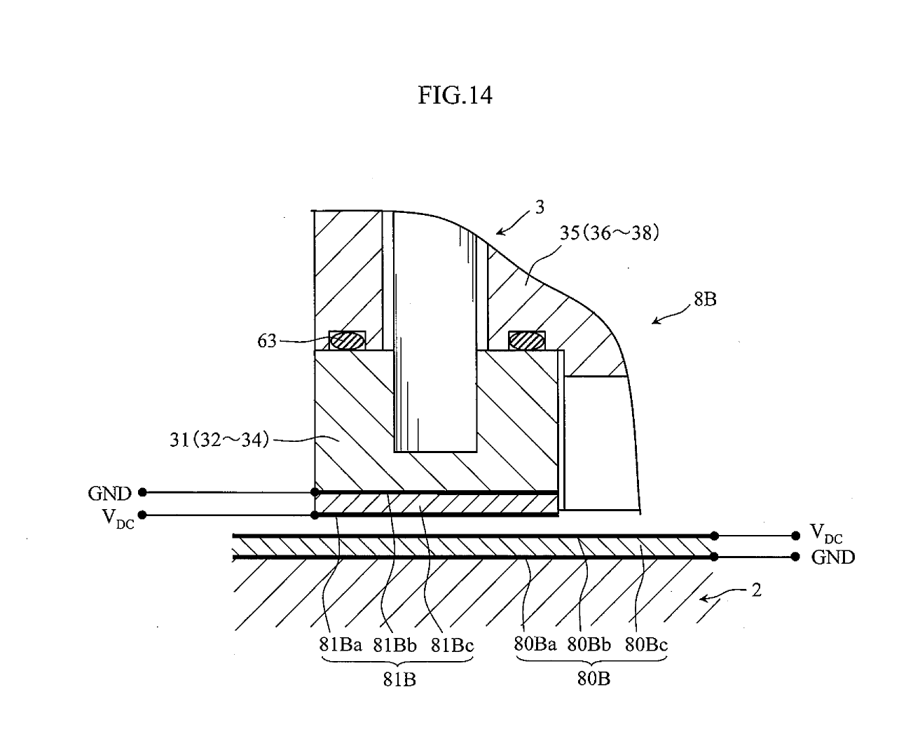

Next, the third embodiment of the present invention is described below with reference to FIG. 14. In this drawing, elements identical to those in the static pressure slider 1 according to the first embodiment (see FIGS. 1-10) are given the same reference numbers and duplicated description is not omitted.

A static pressure slider 8B shown in FIG. 14 has a different structure of first and second conductive layers 80B and 81B from the static pressure slider 1 according to the first embodiment (see FIGS. 1-9).

In the first and second conductive layers 80B and 8113, dielectric layers 80Bc and 81Bc are provided between facing conductive films 80Ba and 81Ba and non-facing conductive films 80Bb and 81Bb respectively. The facing conductive films 80Ba and 81Ba and the non-facing conductive films 80Bb and 81Bb in the first and second conductive layers 80B and 81B can be made of the same materials as the first and second conductive layers 25-28 and 31A-34A of the static pressure slider 1 according to the first embodiment. A thickness of the films is for example 0.01 to 5 μm. Meanwhile, the dielectric layers 80Bc and 81Bc can be made of known dielectric materials such as barium titanate, and a thickness of the layers is for example 1 to 500 μm.

In the static pressure slider 8B, by applying the DC voltage between the facing conductive films 80Ba and 81Ba and the non-facing conductive films 80Bb and 81Bb in the conductive layers 80B and 81B, surfaces of the facing conductive films 80Ba and 81Ba are electrically charged and the electrostatic force acts between the facing conductive film 80Ba of the first conductive layer 80B and the facing conductive film 81Ba of the second conductive layer 81B. When the electrostatic force acts between the facing conductive film 80Ba and the facing conductive film 81Ba and a gap between those conductive films 80Ba and 81Ba is an initial set distance, the displacement bodies 31-34 are preferably positioned at a center of or at a substantially center of a range where the displacement bodies 31-34 are displaceable.

In such a static pressure slider 8B, an electric potential difference between the facing conductive film 80Ba or 81Ba and the non-facing conductive film 80Bb or 81Bb in one of the first conductive layer 80B and the second conductive layer 81B is fixed, while an electric potential difference between the facing conductive film 80Ba or 81Ba and the non-facing conductive film 80Bb or 81Bb in the other conductive layer 80B or 81B is variable. Then, the first conductive layer 80B and the second conductive layer 81B are processed as one variable capacitor. Therefore, by the same circuit as the circuit shown in FIG. 10, the electrostatic force acting between the first and second conductive layers 80B and 81B, that is, the distance between those conductive layers 80B and 81B can be adjusted. Of course, the electric potential difference between the facing conductive films 80Ba and 81Ba and the non-facing conductive films 80Bb and 81Bb in both the first conductive layer 80B and the second conductive layer 81B may be variable, and then the electric potential difference between the facing conductive films 80Ba and 81Ba and the non-facing conductive films 80Bb and 81Bb may be adjusted so as to set the electrostatic force acting between the first and second conductive layers 80B and 81B, that is, the distance between those conductive layers 80B and 81B.

In the static pressure slider 8B, the electrostatic force acting between the first conductive layer 80B and the second conductive layer 81B is adjusted by the electric potential difference between the facing conductive films 80Ba and 81Ba and the non-facing conductive films 80Bb and 81Bb in the first and second conductive layers 80B and 81B. Therefore, it is possible to responsively adjust the distance between the first conductive layer 80B and the second conductive layer 81B. Particularly, at the center of or at the substantially center of the range where the displacement bodies 31-34 are displaceable, when the force acting on the displacement bodies 31-34 by the packings 63 (the elastic restoring force) is balanced with the force acting on the displacement bodies 31-34 by the coil spring 62 (the elastic restoring force), it is possible to easily perform both elastic deformation with a large thickness of the packings 63 and elastic deformation with a small thickness of the packings 63. Therefore, in the static pressure slider 8B, since the displacement bodies 31-34 can be responsively displaced, it is possible to responsively adjust the distance between the first conductive layer 80B and the second conductive layer 81B.

When the distance between these conductive layers 80B and 81B is measured as the capacitance with utilizing the first and second conductive layers 80B and 81B, it is possible to both measure the capacitance (the distance between the first and second conductive layers 80B and 81B) and adjust the electric potential difference (the electrostatic force acting on the first and second conductive layers 80B and 81B) by the first and second conductive layers 80B and 81B. Therefore, in comparison to a case where the mechanism for measuring the distance between the first and second conductive layers 80B and 81B is separately provided, the device structure is simple and the manufacturing cost is advantageous.

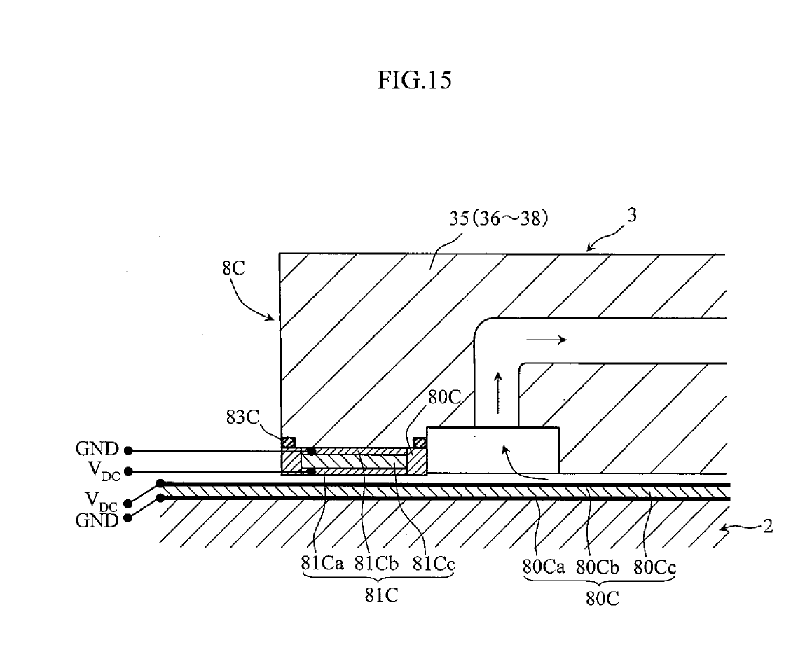

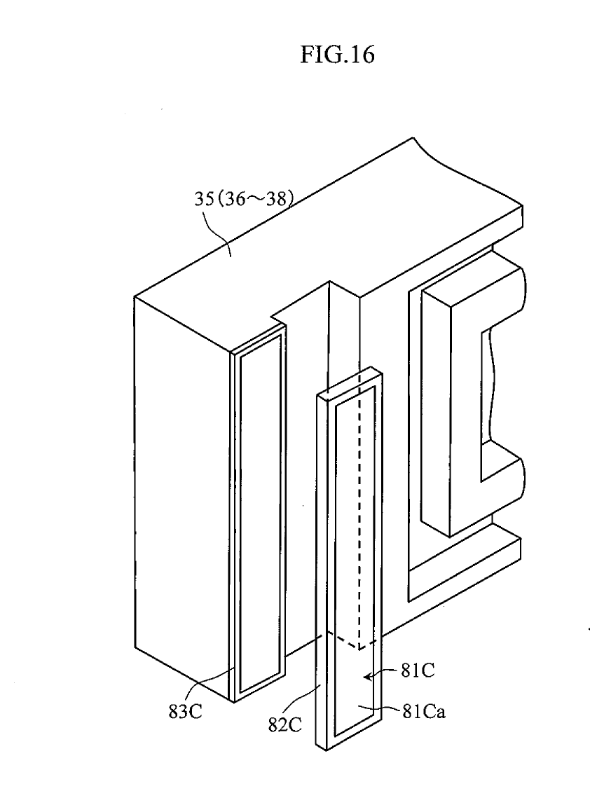

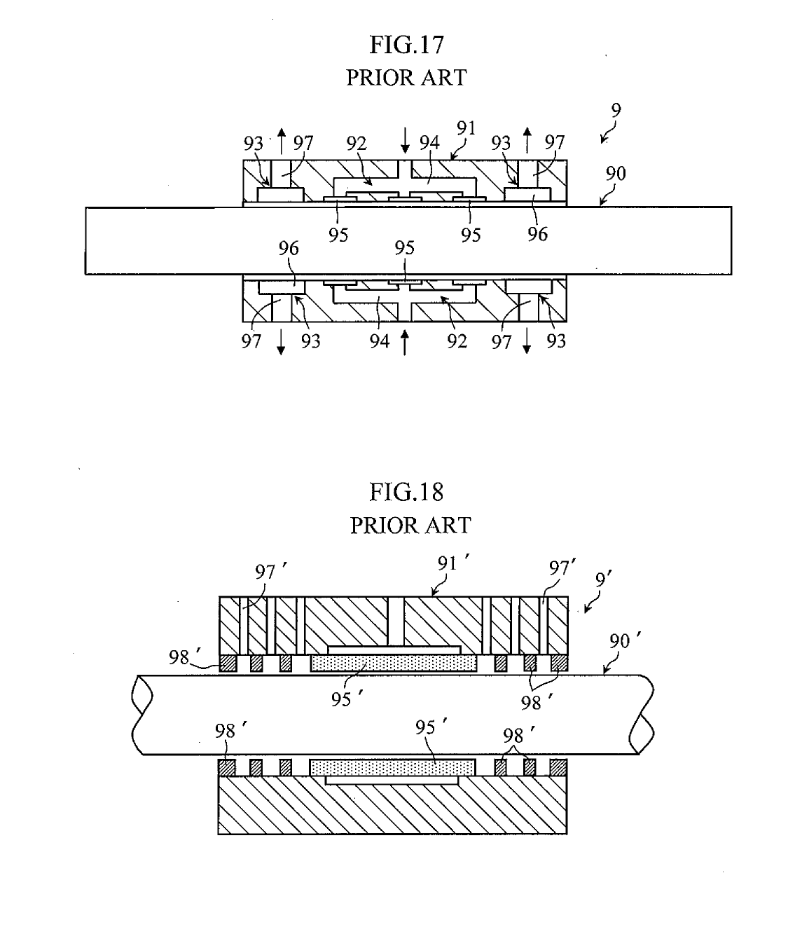

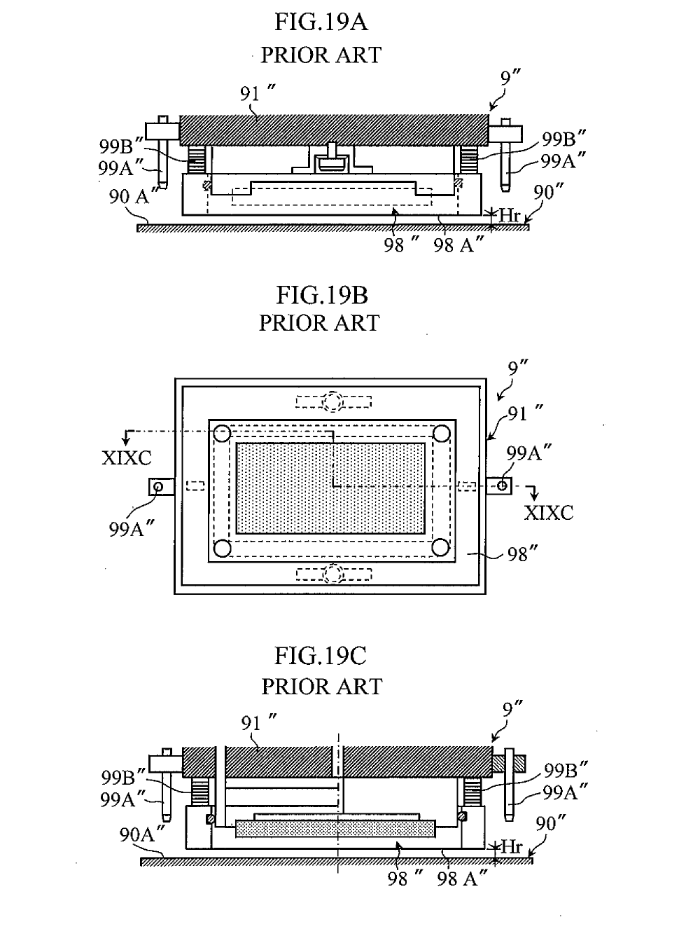

Next, the fourth embodiment of the present invention is described below with reference to FIGS. 15 and 16. In these drawings, elements identical to those in the static pressure slider 1 according to the first embodiment (see FIGS. 1-9) are given the same reference numbers and duplicated description is not shown.

A static pressure slider 8C shown in FIGS. 15 and 16 has a different structure of a second conductive layer 81C from the static pressure slider 8B according to the third embodiment (see FIG. 13).

In first and second conductive layers 80C and 81C, dielectric layers 80Cc and 81Cc are provided between facing conductive films 80Ca and 81Ca and non-facing conductive films 80Cb and 81Cb. As materials for forming the facing conductive films 80Ca and 81Ca, the non-facing conductive films 80Cb and 81Cb, and the dielectric layers 80Cc and 81Cc, the same materials as in the static pressure slider 8B according to the third embodiment (see FIG. 13) can be used, and a thickness is also similar to the static pressure slider 8B.

The second conductive layer 81C is further surrounded by a holder 82C, not fixed to the movable member 3 (the board 35 (36-38)) but completely separated from the movable member 3 (the board 35 (36-38)).

Here, the holder 82C ensures rigidity of the second conductive layer 81C and is formed in a frame-shape by an insulating material. For example, epoxy resin and polyimide resin can be used as a material for forming the holder 82C.

When the holder 82C is provided so as to surround the second conductive layer 81C and the second conductive layer 81C is an independent member from the moveable member 3, it is possible to improve a handling property of the second conductive layer 81C at the time of manufacturing and ensure durability of the members including the second conductive layer 81C and the holder 82C at the time of using. Meanwhile, when the second conductive layer 81C is the independent member, there is no need for a process of fixing the second conductive layer 81C to the movable member 3. Therefore, workability at the time of manufacturing is improved.

Further in the static pressure slider 8C, a sealing material 83C is arranged in a portion where the holder 82C gets into contact with the end portion of the board 35 (36-38). This sealing material 83C functions the same as the sealing members 63 in the static pressure slider 1 according to the first embodiment (see FIG. 8). That is, the sealing material 83C allows the displacement of the second conductive layer 81C and prevents a gap between the second conductive layer 81C and the end portion of the board 35 (36-38).

In the static pressure slider 8C, by applying the DC voltage between the facing conductive films 80Ca and 81Ca and the non-facing conductive films 80Cb and 81Cb in the first and second conductive layers 80C and 81C, surfaces of the facing conductive films 80Ca and 81Ca are electrically charged and the electrostatic force is imposed between the first and second conductive layers 80C and 81C (the facing conductive films 80Ca and 81Ca). That is, in the static pressure slider 8C, the gap between the first conductive layer 80C and the second conductive layer 81C is adjusted by the same operation as the static pressure slider 8B according to the third embodiment (see FIG. 13). Therefore, it is possible to obtain an effect of the static pressure slider 8B according to the third embodiment (see FIG. 13).

The static pressure slider according to the present invention is not limited to the above-described embodiments, and may be variously modified. For example, when the displacement bodies 31-34 are provided as in the static pressure slider 1 or 8B in the first or third embodiment, it is possible to perform the following ON/OFF control: when the first conductive layers 25-28 or 80B get into contact with the second conductive layers 31A-34A or 81B, the electric potential difference is provided between those conductive layers 25-28 or 80B and 31A-34A or 81B; and on the other hand, when the first conductive layers 25-28 or 80B are not in contact with the second conductive layers 31A-34A or 81B, the electric potential difference is not provided between those conductive layers 25-28 or 80B and 31A-34A or 81B.

When the electrostatic force between the first and second conductive layers acts as the attraction force, in order to avoid erroneous operations in a case where electric discharge is caused between these conductive layers, an insulating film may be provided on surfaces of the first and second conductive layers. The insulating film in that case may be a known material, and a thickness of the film is for example not more than 0.1 μm.

The present invention is not limited to be applied to the above-described static pressure slider, but may also be applied to other types of static pressure sliders. For example, the present invention may be applied to a static pressure slider with a cylindrical stationary member and a tubular movable member, as well as to a simple static pressure slider with a levitated flat movable member.

1. A static pressure slider comprising:
a stationary member; and
a movable member configured to be movable relative to the stationary member under a condition that a static pressure fluid layer including a pressurized fluid is provided between the stationary member and the movable member;
wherein the static pressure slider further comprises:
a first conductive layer formed on the stationary member; and
a second conductive layer configured to include a portion which has a first distance from the first conductive layer, the first distance being changeable by an electrostatic force which is to act between the first and second conductive layers.

2. The static pressure slider according to claim 1, wherein
a degree of the electrostatic force which is to act between the first and second conductive layers is adjusted based on a capacitance between the first and second conductive layers.

3. The static pressure slider according to claim 1, wherein
the electrostatic force acting between the first conductive layer and the second conductive layer by applying an electric potential difference between the first and second conductive layers.

4. The static pressure slider according to claim 1, wherein
in one of the first and second conductive layers, a dielectric body is provided between a facing conductive film facing the other conductive layer and a non-facing conductive film, and
the electrostatic force acts between the first conductive layer and the second conductive layer by providing an electric potential difference between the facing conductive films and the non-facing conductive films in the conductive layers to electrically charge surfaces of the facing conductive films.

5. The static pressure slider according to claim 1, wherein
the movable member comprises a main body and a displacement body supported by the main body with a second distance relative to the stationary member changeable, and
the first distance of the second conductive layer relative to the first conductive layer is changeable integrally with the displacement body.

6. The static pressure slider according to claim 5, further comprising:
a sealing member for sealing a gap between the main body and the displacement body, wherein
the sealing member is compressed by the displacement body.

7. The static pressure slider according to claim 1, wherein
the second conductive layer is fixed to the movable member through an elastic body, and the elastic body is elastically deformed so as to change the distance relative to the first conductive layer.

8. The static pressure slider according to claim 1, wherein
the second conductive layer comprises a fixing portion fixed to the movable member and a non-fixing portion with the first distance relative to the first conductive layer changeable.

9. The static pressure slider according to claim 8, wherein
the second conductive layer is a thin plate deformable or displaceable by the electrostatic force, and
the thin plate includes a first end portion constituting the fixing portion, and a second end portion of a free end constituting the non-fixing portion.

10. The static pressure slider according to claim 4, wherein
the second conductive layer is surrounded by a holder and configured to be an independent member separated from the movable member.

11. The static pressure slider according to claim 10, wherein
an elastic body is fixed to a portion of the movable member in contact with the holder.

12. The static pressure slider according to claim 1, wherein
surfaces of the first and second conductive layers are formed to be a smooth surface with a maximum height Rz 1 μm or less.

13. The static pressure slider according to claim 1, wherein
the first and second conductive layers comprise a thick layer including a conductive material.

14. The static pressure slider according to claim 1, wherein
the first and second conductive layers includes a non-magnetic material.

15. A transferring device, comprising:
the static pressure slider according to claim 1 for moving works supported by the movable member; and
a container accommodating the static pressure slider.

16. A processing device, comprising:
the static pressure slider according to claim 1 for moving works supported by the movable member;
a container accommodating the static pressure slider; and
a processing element for checking or processing the works.

17. The processing device according to claim 16, wherein
the processing element includes a scanning electron microscope, an electron beam recorder, a focus ion beam recorder, or an X-ray exposure device.
